(19) United States
(12) Patent Application Publication
(10) Pub. No.: US 2005/0022734 A1
(43) Pub. Date: Feb. 3, 2005

(54) Electrostatic coating apparatus

(76) Inventors: Yasuji Ishii, Oura-gun (JP); Junichi Imai, Oura-gun (JP)

Correspondence Address: MURAMATSU & ASSOCIATES, Suite 225, 7700 Irvine Center Drive, Irvine, CA, 92618, US

(21) Appl. No.: 10/865,068

(22) Filed: Jun. 10, 2004

(30) Foreign Application Priority Data
Jul. 7, 2003 (JP) 2003-271228

(51) Int. Cl. B05C 5/00; B05B 7/06; B05C 5/02

(52) U.S. Cl. 118/629; 118/621

(57) ABSTRACT

The present invention provides an improved electrostatic coating apparatus that prevents imperfections in coating due to lumps of coating particles falling on the work piece. The electrostatic coating apparatus, which has multiple nozzles that spray electrically charged coating particles, has least one connecting member that connects the nozzles to each other, in such a way that the surface of the opening at the tip of the nozzle is inserted in a smooth interior surface of the connecting member. Although some of the coating particles discharged from the nozzles adhere to the interior surface, because the surface is smooth the coating particles can be prevented from concentrating locally into icicles that might fall onto the work piece.

### CLAIM OF PRIORITY

This application claims priority from Japanese Patent Application No. 2003-271228, entitled “Electrostatic Coating Apparatus” filed on Jul. 7, 2003, the entire contents of which are incorporated herein by reference.

### FIELD OF THE INVENTION

The present invention relates to an improved electrostatic coating apparatus, and more particularly, to an electrostatic coating apparatus that prevents drops of paint from forming icicles around the nozzles of the apparatus so as to prevent uneven coating of a work piece.

### BACKGROUND OF THE INVENTION

FIGS. 5A, 5B and 5C are diagrams showing plan, lateral and bottom views of a conventional disk pad, respectively.

A disk pad, used as a friction member in disk brakes and the like, as shown in FIGS. 5A, 5B and 5C, is composed of a back plate 11 and a friction material 12. The back plate 11 is a plate made of a metal such as steel. In the example shown in the diagrams, two projections are provided at the top of the back plate 12, with each projection provided with a hole for attaching the disk pad 10 by a pin.

The friction material 12 is stuck to the back plate 11 so as to leave free the projections and the surrounding area. The friction material 12 is formed by putting a powder that mixes fiber, filler and compound into a mold and compressing and heating the powder.

There are two main methods of forming the friction material 12. One method involves directly pressing the powdered friction material 12 onto the back plate 11. The other method involves pressing the powdered friction material 12 into a semi-finished product that is then laid on the back plate 11 and pressure-heated so as to adhere to the back plate 11. In order to prevent rust and corrosion and to add to the commercial value of the disk pad 10 formed as described, the disk pad is electrostatically coated.

As apparatuses and methods of electrostatically coating such a disk pad, there are the apparatuses and methods disclosed, for example, in Japanese Laid-Open Patent Publication No. 2001-17891 and Japanese Laid-Open Patent Publication No. 2002-292312.

FIGS. 6A and 6B are diagrams showing a conventional electrostatic coating apparatus as disclosed in Japanese Laid-Open Patent Publication No. 2001-17891 and No. 2002-292312, in which FIG. 6A shows a front view of the interior of a coating chamber of the conventional electrostatic coating apparatus and FIG. 6B shows a top view of a nozzle of such apparatus. An insulated conveyor belt 30 is disposed so as to pass through the coating chamber. A disk pad 10 is set on the conveyor belt 30 with the friction material 12 beneath the back plate 11, so that coating particles do not attach to a friction surface of the friction material 12.

A coating apparatus 20 is mounted at a top of the coating chamber, with a plurality of nozzles 21 that spray coating particles projecting from both sides of the coating apparatus 20. As shown in FIG. 6A, the coating apparatus 20 projects outward laterally via curved portions a and b, with the plurality of nozzles 21 on each side linked by a single bar-like lateral strip extending in a direction perpendicular to the direction of extension of the nozzles 21, the two lateral strips 22 being connected by a single bar 23 supported from a vertically positioned strut 24 at the center of the coating apparatus 20 so as to connect the nozzles 21, comprising multiple small tubes, into a single integrated structure. Tips of the nozzles 21 face inward, so that particles of coating in powder form are discharged onto rear and lateral surfaces of the disk pad 10 from several of the nozzles 21. The back plate 11 is larger than the friction material 12, and therefore it is difficult to coat the bottom surface of the back plate 11 with coating particle powder discharged only from directly above the back plate 11.

As the disk pad 10, which is placed on the conveyor belt 30, is conveyed toward a position directly beneath the coating apparatus 20, an electrode 31 used as a ground contacts the disk pad 10, grounding the disk pad 10. The disk pad 10, including not only the back plate 11 but also usually the friction material 12, contains a substantial amount of metal particles and is therefore electrically conductive, and therefore the ground electrode 31 can ground the disk pad 10 by contacting virtually any part of the disk pad 10. The coating particles are charged by friction when passing through the coating apparatus 20, and therefore adhere to every part of the disk pad 10 when discharged from the coating apparatus 20.

The disk pad 10, which is now covered with coating particles, exits the coating chamber and is heated and baked in a baking chamber. The coating particles are melted and then cooled and hardened to form a coating layer on the disk pad 10.

The coating apparatus 20, as shown in FIG. 6A, is composed of multiple projecting nozzles 21, laterally connected to each other by the lateral strips 22 at tip portions thereof. Additionally, of the coating particles discharged from the nozzles 21, a substantial portion do not attach themselves to the back plate 11 but remain suspended in mid-air. These coating particles suspended in air then attach themselves to the nozzles 21 and to the bars 22, 23 and 24.

However, such particles do not evenly coat the surfaces of the nozzles 21 and bars 22, 23 and 24 but instead form as icicle-like projections (hereinafter icicles) at angled areas and at projections. These icicles of coating particles fall off when they attain a certain length, with the resulting lumps of coating particles adhering to the back plate 11 and causing unevenness and imperfections in the coating.

### BRIEF SUMMARY OF THE INVENTION

The present invention is conceived in light of the foregoing drawback of the conventional art, and has as an object to provide an improved electrostatic coating apparatus in which lumps of coating particles do not fall onto the back plate and cause unevenness and imperfections in the coating.

According to a first aspect of the present invention, the foregoing object is attained by providing an electrostatic coating apparatus having a plurality of nozzles that spray electrically charged coating particles, the apparatus comprising:

least one connecting member that connects the plurality of nozzles, the connecting member having a smooth interior surface,

a surface of an opening at a tip of each of the plurality of nozzles disposed within the smooth interior surface of the connecting member.

According to a second aspect of the present invention, the foregoing object is also attained by providing an electrostatic coating apparatus as described above, having one connecting member wherein the smooth surface is an inwardly concave curved surface.

According to a third aspect of the present invention, the foregoing object is also attained by providing an electrostatic coating apparatus as described above, wherein the inwardly concave curved surface is cylindrical.

Preferably, a rim of each of the plurality of nozzles is arc-shaped in cross section.

According to the invention described above, when the charged coating particles are discharged from the plurality of nozzles toward the work piece, the coating particles adhere to the surface of the work piece to form a layer of coating particles. The coating particles that do not adhere to the work piece fall onto the surface of the conveyer belt on which the work piece rests, adhere to the connecting member supporting the nozzles, and so forth. The attachment surface of the connecting member is a smooth surface, however, and therefore the coating particles adhere to the surface evenly, without concentrating locally into icicles. Since icicles do not form, lumps of coating particles do not fall onto the work piece or conveyor belt, and therefore unevenness and imperfections in the coating can be prevented.

If the smooth surface of the connecting member is inwardly concave, the work piece can be enclosed from all sides within a single unit and the occurrence of icicles can be prevented.

If the concave surface is cylindrical, the work piece can be conveyed along the conveyor belt without interference from the connecting member.

As described above, the present invention, in an electrostatic coating apparatus provided with a plurality of nozzles that spray electrostatically charged coating particles, connects the nozzles with least one connecting member, with the surface of the openings at the tips of the nozzles disposed within a smooth surface of the connecting member. As a result, when the charged coating particles are discharged from the nozzles, the present invention prevents the formation of icicles of coating particles even if excess coating particles adhere to the surface of the connecting member, and thus can prevent unevenness and imperfections in the coating.

Other features and advantages of the present invention will be apparent from the following description when taken in conjunction with the accompanying drawings, in which like reference characters designate identical or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a diagram showing a front cross-sectional view of the main parts of an electrostatic coating apparatus in the present invention;

FIG. 2 is a diagram showing a bottom view of an interior surface of a connecting member;

FIG. 3 is an enlarged lateral cross-sectional view of a connecting portion between a through-hole of the connecting member and a nozzle;

FIG. 4 is a diagram showing a front cross-sectional view of the main parts of an electrostatic coating apparatus according to a second embodiment of the present invention;

FIGS. 5A, 5B and 5C are diagrams showing plan lateral and bottom views of a conventional disk pad, respectively; and

FIGS. 6A and 6B are diagrams showing front and top views of the interior of a coating chamber of a conventional electrostatic coating apparatus.

### DETAILED DESCRIPTION OF THE INVENTION

Preferred embodiments of the present invention are now described in detail in accordance with the accompanying drawings.

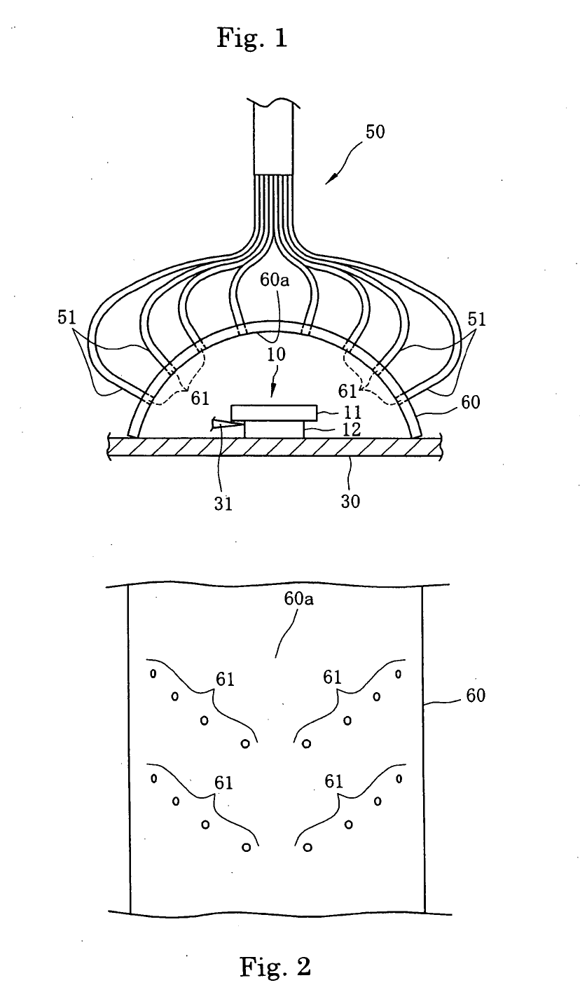

FIG. 1 is a diagram showing a front view of the main parts of an electrostatic coating apparatus in the present invention.

As shown in FIG. 1, a conveyor belt 30 is disposed so as to convey a work piece through a coating chamber, not shown. Preferably, the conveyor belt 30, which may be made of urethane or some other suitable material, is not electrically conductive, in order to facilitate the collection for reuse of coating particles. A disk pad 10 is set on the conveyor belt 30 so that friction material 12 faces down.

A coating apparatus 50 is mounted on a roof of the coating chamber. A plurality of nozzles 51 that spray coating particles is disposed along both sides of the coating apparatus 50. Preferably, the nozzles 51 are made of a non-conductive material, which may be polyvinyl chloride or some other, suitable material. As in the conventional art, the nozzles 51 are disposed in an outwardly concave arrangement, with the plurality of nozzles connected at their tips by a connecting member 60. Preferably, the nozzles 51 are connected substantially at right angles to the connecting member 60. The connecting member 60, which is hemispherical in cross-section, is substantially an empty cylinder partially cut away, so as to form a unitary cover over the top of the conveyer belt 30.

FIG. 2 is a diagram showing a bottom view of an interior surface of a connecting member, that is, the connecting member 60 of FIG. 1. As shown in the diagram, the connecting member 60 is provided with a plurality of through-holes 61 corresponding to the plurality of nozzles 51, with each through-hole 61 forming an opening at the tip of each one of the nozzles 51. In other words, the nozzles 51 do not project inwardly beyond the smooth interior surface of the connecting member 60.

The cylindrically shaped connecting member 60 extends in a direction of conveyance of a work piece 10 along the conveyor belt 30. The work piece passes through the tunnel-like space formed by the connecting member 60 and is sprayed with coating particles along the way. The through-holes 61 that form the openings of the nozzles 51 are positioned away from both an entry end and an exit end of the connecting member 60, thus enabling a reduction of the amount of coating particles escaping from either such longitudinal end of the tunnel-like interior space to the exterior of the connecting member 60. As a result of such a disposition, it is difficult for excess coating particles to accumulate on an exterior surface of the connecting member 60, thus reducing the risk of coating particles accumulating on the exterior falling onto work pieces 10 being conveyed by the conveyor belt 30. In addition, such a disposition decreases the frequency of cleaning required.

It should be noted that the smooth surface described above is not a surface that has been particularly highly polished, but rather denotes merely a surface free from blemishes, such as projections or depressions.

Moreover, as can be appreciated by those of ordinary skill in the art, although the through-holes 61 that accommodate the tips of the nozzles 51 are arranged in the manner shown in FIGS. 1 and 2, the present invention is not limited to such a disposition, the arrangement shown in FIGS. 1 and 2 being merely illustrative and not definitive of the present invention.

As shown in FIG. 1, the connecting member 60 is in the shape of a partial cylinder, substantially hemispherical in cross-section, with lateral edges thereof in contact with an upper surface of the conveyor belt 30. The longitudinal ends, that is, the entry and exit ends, of the connecting member 60 form semi-circular openings, so as not to hinder the passage of the work pieces 10 either into or out of the tunnel-like interior space formed by the connecting member 60. Such a disposition enables the disk pad 10 to be discharged from a plurality of directions when coated with the electrically charged coating particles discharged from the nozzles 51, and moreover, increases the density of coating particles within a space enclosed by the connecting member 60 and the conveyor belt 30, thus facilitating the uniform coating of the surface of the back plate 11.

At the same time, of the coating particles floating free within such space, some fall onto the conveyor belt 30 and are conveyed together with the conveyor belt 30 to the exterior, where such coating particles are collected and recovered for later reuse at a suitable location. Coating particles that adhere to an interior surface 60a of the connecting member 60 also substantially evenly coat such interior surface 60a because such interior surface 60a is substantially free of blemishes such as projections and depressions, and hence the coating particles do not form icicle lumps. As a result, since icicles do not form, lumps of coating particles do not fall onto the work piece or conveyor belt, and therefore unevenness and imperfections in the coating can be prevented.

Thereafter, the back plate 11 is conveyed to a baking oven, where it is heated and baked to form a coating layer of uniform thickness, thus enabling a layer of coating particles of uniform thickness to be formed where required.

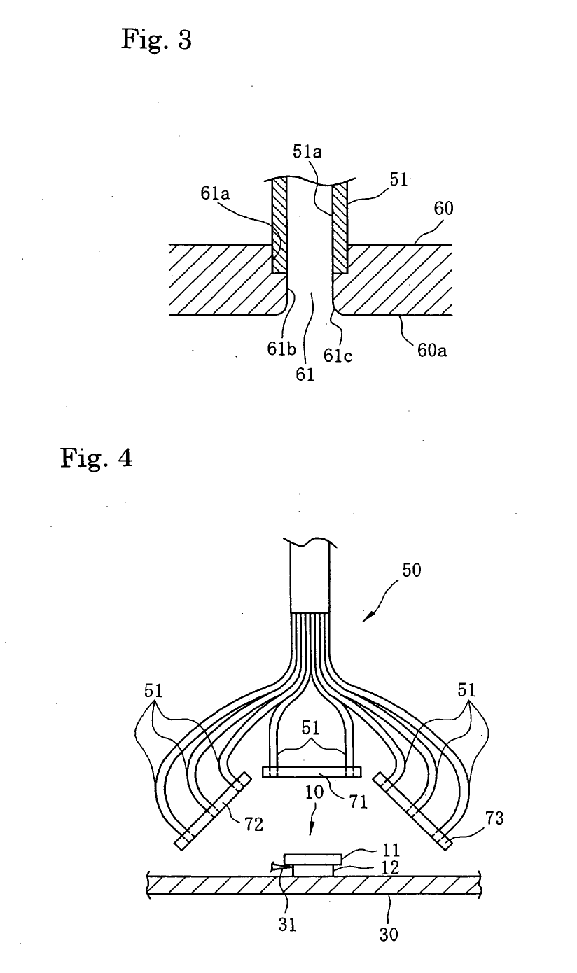

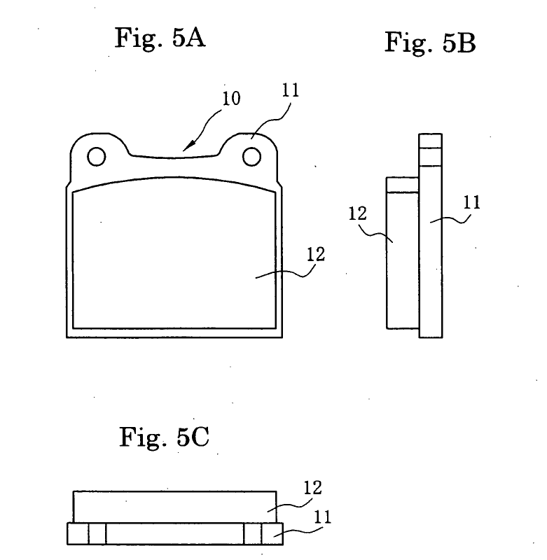

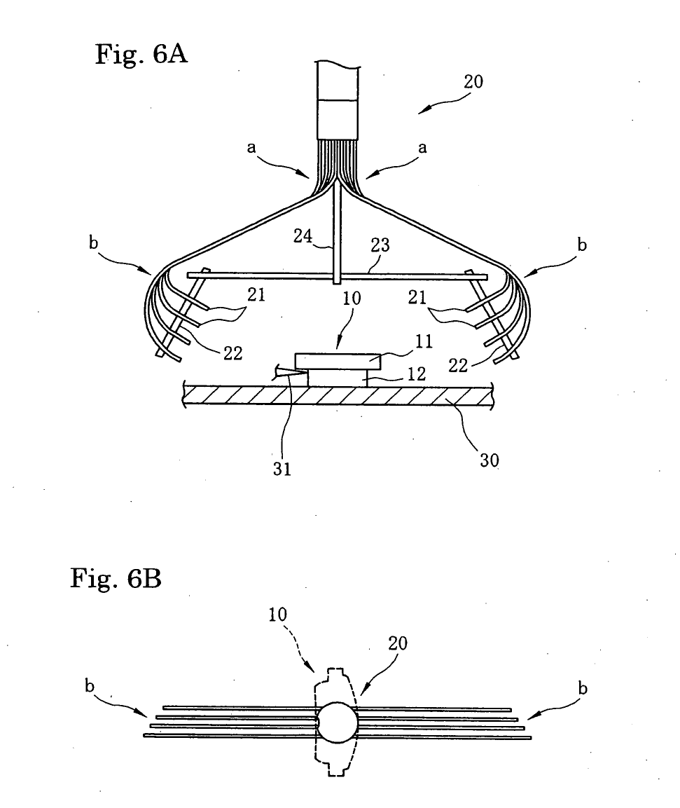

FIG. 3 is an enlarged lateral cross-sectional view of a connecting portion between a through-hole of the connecting member and a nozzle, specifically, of the connection between the through-holes 61 of the connecting member 60 and the nozzles 51. Each through-hole 61 is a stepped aperture, with a first, larger-diameter section 61a comprising approximately half the length of the through-hole 61 and a second, smaller-diameter section 61b comprising substantially the remaining half of the length of the through-hole 61. The tip of the nozzle 51 engages the first, larger-diameter section 61a, so that a diameter of an interior surface 51a of the nozzle 51 matches the diameter of the second, smaller-diameter section 61b. The joint between the nozzle 51 and the through-hole 61 is sealed by an appropriate method so that no gap exists between the tip of the nozzle 51 and the through-hole 61 of the connecting member 60. In addition, an edge portion 61c of the through-hole 61 at the interior surface 60a of the connecting member 60b is substantially arc-shaped in cross-section, so as not to form any pointed portion. Points such as these and gaps can allow icicles of coating particles to form, causing unevenness and imperfections in the coating.

It should be noted that the joint between the nozzle 51 and the connecting member 60 shown in FIG. 3 is but one example of such a connection, and is illustrative rather than definitive thereof. Thus, alternatively, for example, the tip of the nozzle 51 may be connected to a surface opposite the interior surface 60a of the connecting member 60b, or penetrate the connecting member 60 to the interior surface 60a of the connecting member 60. In any case, the surface of the tip of the nozzle remains the smooth interior surface 60a of the connecting member 60.

FIG. 4 is a diagram showing a front cross-sectional view of the main parts of an electrostatic coating apparatus according to a second embodiment of the present invention. Parts that are identical or similar to those of the embodiment shown in FIG. 1 described above are given the same reference characters, and the description concentrates on areas of the second embodiment that are different from the embodiment shown in FIG. 1.

In the second embodiment, the connecting member 60 is comprised of a plurality of plates. In other words, the plurality of nozzles 51 is divided into three groups, with a central group of nozzles 51 being attached to a central connecting member 71, nozzles 51 at the left of the diagram attached to a left lateral connecting member 72, and nozzles 51 at the right of the diagram attached to a right lateral connecting member 73.

As with the embodiment shown in FIG. 1, each of the connecting members 71, 72 and 73 is provided with through-holes, each one of which engages one of a plurality of nozzles 51.

With the structure of the second embodiment as well, the surfaces of the openings of the nozzles are within the flat interior surfaces of the connecting members 71, 72 and 73 that face the work piece, and, since these flat interior surfaces contain no projections or depressions, the coating particles adhere to the surface evenly and the formation of icicles of coating particles can be prevented.

Although in the above-described embodiments the smooth interior surface of the connecting member is shown as a cylindrical surface or a flat surface, the present invention is not limited to such configurations. Provided that the surface is a smooth one, any of a variety of possible surface configurations may be used, including, but not limited to, a sphere, or, in cross-section, an oval or a horseshoe shape.

Additionally, although the connecting members 60 and 71, 72, 73 are shown as plates in the embodiments described above, the connecting member of the present invention is not limited to such a construction. Thus, provided that the surface of the opening of the nozzle 51 remains a smooth surface, the connecting member 60 may, for example, be shaped as a block.

As many apparently widely different embodiments of the present invention can be made without departing from the spirit and scope thereof, it is to be understood that the invention is not limited to the specific embodiments described herein except as defined in the appended claims.

1. An electrostatic coating apparatus having a plurality of nozzles that spray electrically charged coating particles, the apparatus comprising:
least one connecting member that connects the plurality of nozzles, the connecting member having a smooth interior surface,
a surface of an opening at a tip of each of the plurality of nozzles disposed within the smooth interior surface of the connecting member.

2. The electrostatic coating apparatus as claimed in claim 1, having one connecting member wherein the smooth surface is an inwardly concave curved surface.

3. The electrostatic coating apparatus as claimed in claim 2, wherein the inwardly concave curved surface is cylindrical.

4. The electrostatic coating apparatus as claimed in claim 1, wherein a rim of each of the plurality of nozzles is arc-shaped in cross section.
